(19) United States
(12) Patent Application Publication
(10) Pub. No.: US 2010/0231461 A1
(43) Pub. Date: Sep. 16, 2010

(54) FREQUENCY SELECTIVE MULTI-BAND ANTENNA FOR WIRELESS COMMUNICATION DEVICES

(75) Inventor: Allen Minh-Triet Tran, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/404,175

(22) Filed: Mar. 13, 2009

(51) Int. Cl. H01Q 9/04; H01Q 1/24

(52) U.S. Cl. 343/702; 343/700 MS

(57) ABSTRACT

A multi-band antenna with improved antenna efficiency across a broad range of operative frequency bands with reduced physical size is described. The multi-band antenna includes a modified monopole element coupled to multiple antenna loading elements variably selectable to tune to one of a plurality of resonant frequencies. In one exemplary embodiment, the modified monopole element has a geometry other than that of a traditional monopole element and includes a switch array disposed between the modified monopole element and the multiple antenna loading elements and configured to couple a selected one or more of the antenna loading elements to the modified monopole element when tuning to a desired one of the plurality of resonant frequencies. The multi-band antenna resonant frequency is controlled by a wireless communication device selecting among the multiple antenna loading elements for tuning the multi-band antenna between operative frequency bands.

### TECHNICAL FIELD

The present disclosure relates generally to radio frequency (RF) antennas, and more specifically to multi-band RF antennas.

### BACKGROUND

The number of radios and supported frequency bands for wireless communication devices continues to increase as there are increasing demands for new features and higher data throughput. Some examples of new features include multiple voice/data communication links—GSM, CDMA, WCDMA, LTE, EVDO—each in multiple frequency bands (CDMA450, US cellular CDMA/GSM, US PCS CDMA/GSM/WCDMA/LTE/EVDO, IMT CDMA/WCDMA/LTE, GSM900, DCS), short range communication links (Bluetooth, UWB), broadcast media reception (MediaFLO, DVB-H), high speed internet access (UMB, HSPA, 802.11a/b/g/n, EVDO), and position location technologies (GPS, Galileo). With each of these new features in a wireless communication device, the number of radios and frequency bands is incrementally increased and the complexity and design challenges for a multi-band antenna supporting each frequency band as well as potentially multiple antennas (for receive and/or transmit diversity) may increase significantly.

One traditional solution for a multi-band antenna is to design a structure that resonates in multiple (a plurality of) frequency bands. Controlling the multi-band antenna input impedance as well as enhancing the antenna radiation efficiency (across a wide range of operative frequency bands) is restricted by the geometry of the multi-band antenna structure and the matching circuit between the multi-band antenna and the radio(s) within the wireless communication device. Often when this design approach is taken, the geometry of the antenna structure is very complex and the physical area/volume of the antenna increases.

With the limitations on designing multi-band antennas with high antenna radiation efficiency and associated matching circuits, another solution is utilizing multiple antenna elements to cover multiple operative frequency bands. In a particular application, a cellular phone with US cellular, US PCS, and GPS radios may utilize one antenna for each operative frequency band (each antenna operates in a single radio frequency band). The drawbacks to this approach are additional area/volume and the additional cost of multiple single-band antenna elements.

In certain applications of multi-band antennas, the multi-band antenna match is adjusted electronically (with a single-pole multi-throw switch) to select an optimal match for the multi-band antenna (with 50 ohms) at a particular operative frequency band; i.e., between US cellular, US PCS, and GPS is but one example. This multi-band antenna performance may degrade as more frequency bands are added, as the multi-band antenna structure is not changed for different operative frequency bands.

There is a need for a multi-band antenna with improved radiation efficiency across a broad range of operative frequencies for wireless communication devices without the size penalty of traditional designs.

### BRIEF DESCRIPTION OF THE DRAWINGS

FIG. 1 shows a three dimensional drawing of a traditional monopole antenna.

FIG. 2 shows a two dimensional drawing of a multi-band antenna.

FIG. 3 shows a three dimensional drawing of a multi-band antenna.

FIG. 4 shows a drawing of a portable computer with four multi-band antennas.

FIG. 5 shows a drawing of a handheld wireless communication device with two multi-band antennas.

FIG. 6 shows a graph of the multi-band antenna efficiency (450 to 1000 MHz) for a portable computer configuration.

FIG. 7 shows a graph of the multi-band antenna efficiency (1000 to 6000 MHz) for a portable computer configuration.

FIG. 8 shows a graph of the multi-band antenna efficiency (450 to 1000 MHz) for a handheld wireless communication device configuration.

FIG. 9 shows a graph of the multi-band antenna efficiency (1000 to 6000 MHz) for a handheld wireless communication device configuration.

To facilitate understanding, identical reference numerals have been used where possible to designate identical elements that are common to the figures, except that suffixes may be added, when appropriate, to differentiate such elements. The images in the drawings are simplified for illustrative purposes and are not necessarily depicted to scale.

The appended drawings illustrate exemplary configurations of the disclosure and, as such, should not be considered as limiting the scope of the disclosure that may admit to other equally effective configurations. Correspondingly, it has been contemplated that features of some configurations may be beneficially incorporated in other configurations without further recitation.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

The device described therein may be used for various multi-band antenna designs including, but not limited to wireless communication devices for cellular, PCS, and IMT frequency bands and air-interfaces such as CDMA, TDMA, FDMA, OFDMA, and SC-FDMA. In addition to cellular, PCS or IMT network standards and frequency bands, this device may be used for local-area or personal-area network standards, WLAN, Bluetooth, & ultra-wideband (UWB).

Modern wireless communication devices require antennas to transmit and receive radio frequency signals for a variety of applications. In many designs, the wireless communication device antennas include one or more monopole elements placed above the wireless communication device ground plane. Monopole antenna elements provide sufficient antenna gain if the electrical length of the antenna structure resonates at the desired operating frequency. The wireless communication device and antennas may be incorporated in handheld devices (cellular phones for voice applications, portable video phones, smart phones, tracking GPS+WAN devices, and the like) and portable computing devices (laptops, notebooks, tablet personal computers, netbooks and the like).

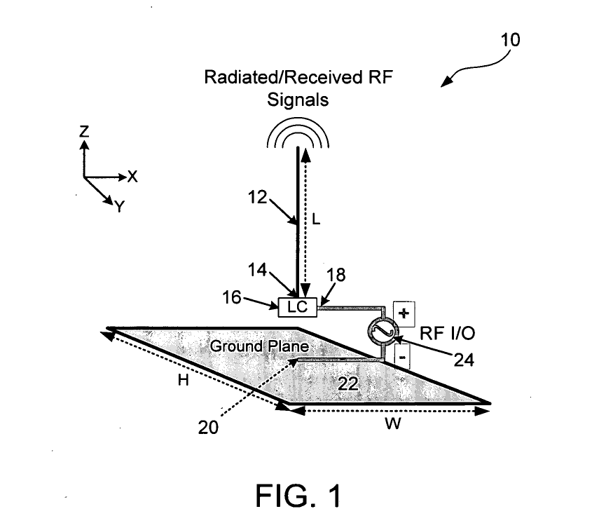

FIG. 1 shows a three dimensional drawing of a traditional monopole antenna. Monopole antenna 10 is a type of radio antenna formed by replacing a lower half of a dipole antenna with a ground plane 22 normal (in three dimensions) to a radiating monopole antenna element 12. If ground plane 22 is large (in terms of wavelength at the desired radio frequency), radiating monopole antenna element 12 behaves exactly like a dipole, as if its reflection in ground plane 22 forms the missing half of the dipole.

Monopole antenna system 10 will have a directive gain of 3 dBi in the ideal case at the resonant frequency defined by the electrical length L of monopole antenna element 12. Monopole antenna 10 will also have a lower input resistance as measured between antenna port 14 and ground plane 22 (measured at RF port 20) than RF I/O source 24, resulting in overall lower antenna efficiency.

The input impedance of monopole antenna element 12 may be transformed to match RF I/O source 24 to improve antenna efficiency, as measured at antenna port 18, utilizing an inductor-capacitor matching network (LC 16). However, LC 16 will only provide an optimal impedance match at one operating radio frequency and LC 16 will introduce losses (in terms of insertion loss) associated with the quality (Q) of both inductor and capacitors in real circuits.

The electrical length can be realized with a wire length L. The wire length L is typically a quarter wavelength (or greater) of the operating frequency in free space depending on the ground plane dimensions of the wireless communication device. In one design example, if wire length L is equal to a quarter wavelength of the operating frequency, the input impedance of monopole antenna element 12 as measured at antenna port 18 will be approximately 50 ohms and is matched to RF I/O source 24.

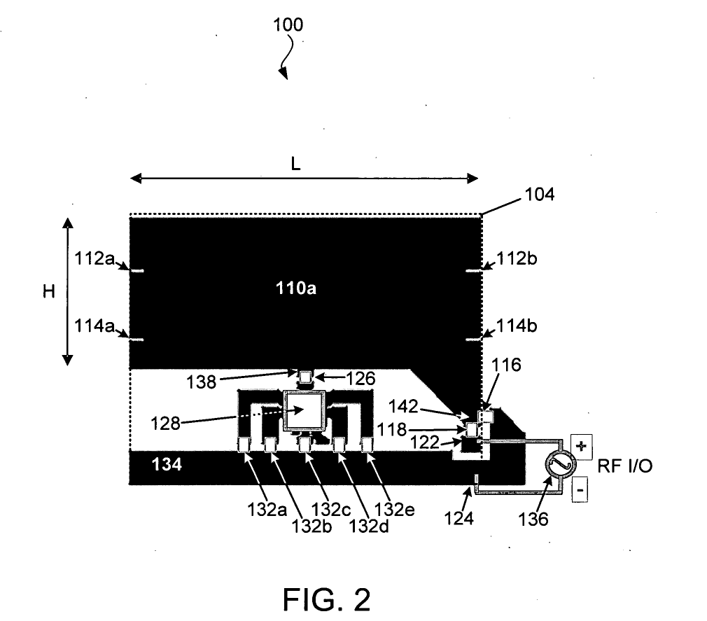

FIG. 2 shows a two dimensional drawing of a multi-band antenna 100 in accordance with an exemplary embodiment.

Multi-band antenna 100 is formed on a flexible printed circuit board 104 which includes a modified monopole element 110a with indents 112a, 112b, 114a, and 114b to fold the modified monopole antenna element 110a with the correct dimensions for a specific wireless communication device application.

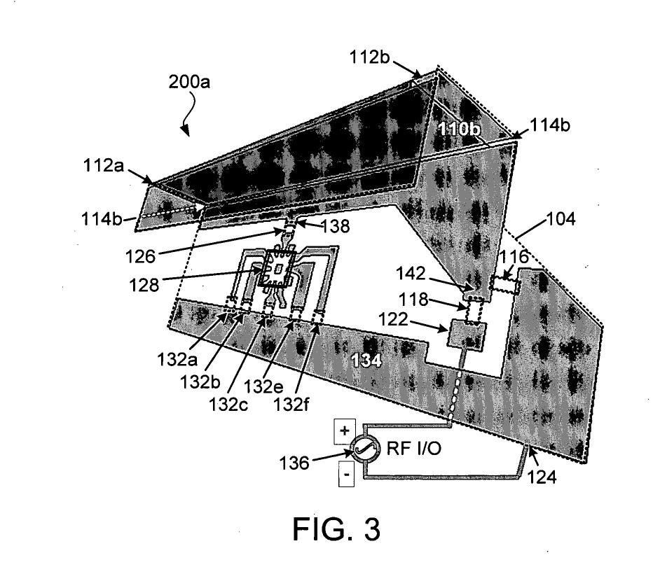

In one exemplary embodiment, the length L of modified monopole element 110a is 25 mm, the height H is 11 mm and when folded, the overall dimensions of the multi-band antenna 100 are 25 mm×7 mm×5 mm. Other physical dimensions may be required for different operative band configurations. Other physical shapes may be required for different or physical constraints of the wireless communication device and may be physically represented by metallized structures formed (e.g., stamped) in either two or three dimensions as shown in FIG. 3. Such two- or three-dimensional shapes may include but are not limited to ellipses, half or quarter ellipses, rectangles, circles, half-circles, meandering micro-strip transmission lines, and polygons. Additionally, the reference ground plane (ground plane 134 in FIGS. 2-3) may not be normal (in 3 dimensions) to the monopole antenna element 110a, however the antenna efficiency and radiation pattern will be or altered relative to the traditional monopole antenna 10 previously shown in FIG. 1. In both instances—antenna physical dimensions and reference ground plane configuration, the resulting antenna structure is referred to as a modified monopole element (modified monopole element 110a in FIG. 2 and modified monopole element 110b in FIG. 3) within this disclosure. The metal structures may be stamped and/or form

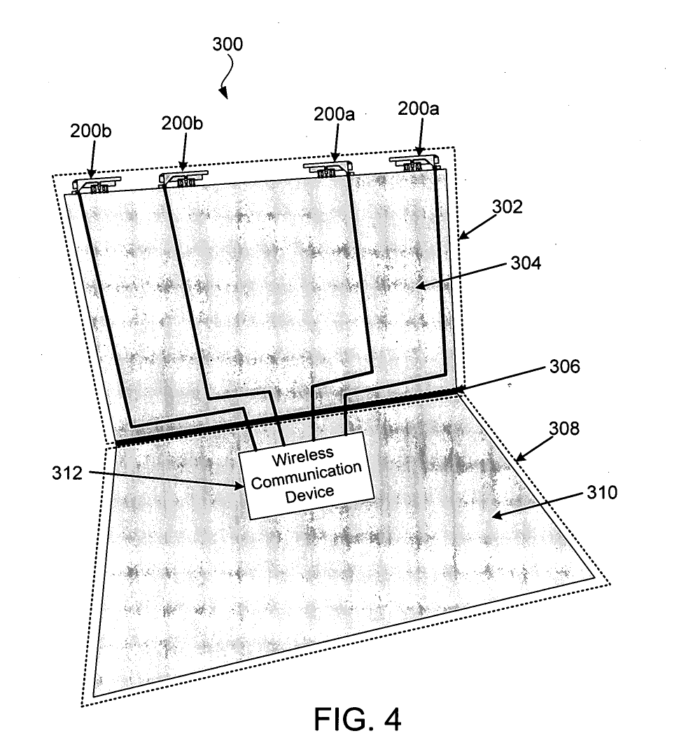

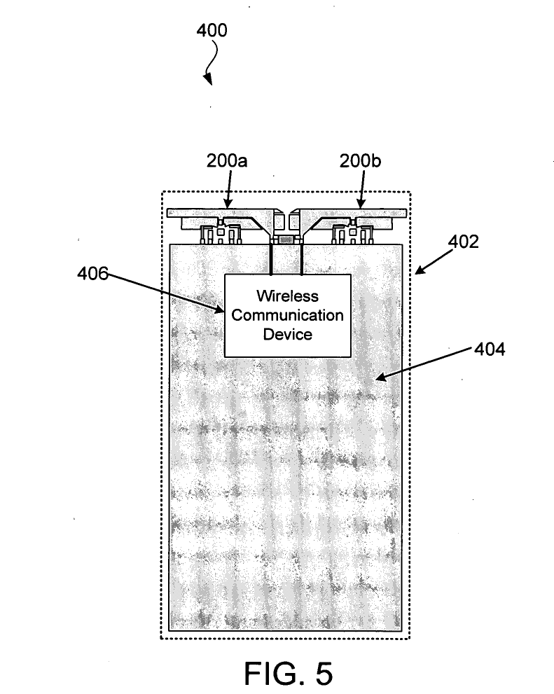

The multi-band antenna 100 include antenna matching components 116 and 118 to transform modified monopole element 110a impedance, measured at a first radio frequency input 142, across a range of frequencies, to match RF I/O port 136 impedance as measured at an external radio frequency (RF) port 122. In the exemplary embodiment, antenna matching component 116 is connected along the lower right edge of the modified monopole element 110a to external radio frequency (RF) port 122 and to ground plane 134. Ground plane 134 is connected to or shares in whole or in part the ground plane of a wireless communication device (as shown in FIG. 4 and FIG. 5). Antenna matching component 118 is connected in series with the external radio frequency (RF) port 122 and the first radio frequency input 142 between modified monopole element 110a and antenna matching component 116. RF I/O port 136 is connected across multi-band antenna 100 external radio frequency (RF) port 122 (positive signal node) and RF ground node 124 (ground or negative signal node).

As shown in FIG. 2, the operative frequency band of multi-band antenna 100 is changed by controlling a single-pole five-throw switch (switch 128) position. A common port of the switch 128 is connected to a DC blocking capacitor 126. DC blocking capacitor 126 is connected between the common port of switch 128 and the modified monopole element 110a at a second radio frequency input 138. The five individual ports of switch 128 each connect to a corresponding one of a set of antenna loading elements, which set in the present example is shown comprised of antenna loading capacitors 132a, 132b, 132c, 132d, and 132e. The value of each antenna loading capacitor is selected for a particular operative frequency band to achieve the optimal bandwidth and center frequency in each instance.

The second radio frequency input 138—where DC blocking capacitor 126 along with switch 128 connect to the modified monopole element 110a and antenna loading capacitors 132a-132e connect to ground plane 134—may be shifted left to right to optimize the bandwidth and center frequency of multi-band antenna 100. The bandwidth of a selected operative frequency band is defined by the physical dimensions of multi-band antenna 100 and to some extent the reference ground plane of the wireless communication device connected to ground plane 134.

Switch control for switch 128 is not shown, but is usually a set of digital signals for enabling individual ones of the antenna loading capacitors 132a-132e to connect to the second radio frequency input 138 through series DC blocking capacitor 126. Control signals originate from the wireless communication device (312 in FIG. 3 or 406 in FIG. 4) that multi-band antenna 100 is a part. Additional multi-band antennas can be added for simultaneous operation in multiple frequency bands, receive and/or transmit diversity for higher throughput applications (EVDO, HSPA, 802.11n are few examples).

Switch 128 may be replaced with discrete switch circuits (SPST, SP2T, SP3T, etc and combinations thereof) and the number of RF common input and RF loading output ports may be changed based on the number of operative frequency bands, required bandwidth and radiation efficiency of multi-band antenna 100.

In alternate exemplary embodiments, multiple switch positions change simultaneously to subtract or add multiple antenna loading capacitors, thereby increasing the number of possible operative frequency bands. DC blocking capacitor 126 is only required if there is a DC current path from each common switch port to ground.

Additionally, antenna loading capacitors 132a-132e may be replaced with a different number of lumped or distributed loading elements (depending on the number of operative frequency bands for switch 128). In particular, antenna loading capacitors may be replaced with voltage variable capacitors, inductors or a series or parallel combination of inductors and capacitors (LC circuits and integrated LC circuits) or equivalent antenna loading elements. The physical position of individual antenna loading capacitors, inductors or LC circuits (antenna loading elements) may be anywhere between the gap between modified monopole element 110a, switch 128, and ground plane 134. In an exemplary embodiment, the individual antenna loading capacitors are connected between ground plane 134 and switch 128 individual RF loading ports.

The multi-band antenna 100 of FIG. 2 exhibits a substantial improvement in antenna radiation efficiency and allows one multi-band antenna 100 to (i) replace the functionality of multiple single-band antennas (shown in FIG. 1) for different operative frequency bands and (ii) reduce the size of the antenna system. As a result, circuit board floor-plan and layout are simplified, wireless communication device size is reduced, and ultimately the wireless communication device features and form are enhanced.

FIG. 3 shows a three dimensional drawing of a multi-band antenna 200a in accordance with an exemplary embodiment. The only difference between multi-band antenna 100 from FIG. 2 and 200a in FIG. 3 is that modified monopole element 110a is replaced with folded modified monopole element 110b to show how the multi-band antenna 200a may appear in three dimensions as shown in the exemplary embodiment to change the physical volume and dimensions of multi-band antenna 200a shown in FIG. 3 relative to multi-band antenna 100 of FIG. 2.

FIG. 4 shows a diagram of a portable computer 300 with four multi-band antennas 200a (two of each) and 200b (two of each) in accordance with the exemplary embodiment as shown previously in FIG. 2 and FIG. 3. Each multi-band antenna is tunable over a range of frequencies to cover all the potential communication modes and operative frequency bands. Individual multi-band antennas may be tuned to different operative frequency bands or the same operative frequency band depending on the number of concurrent communication modes. For example, one multi-band antenna may be tuned to US cellular (for long-range data and voice communication), a second multi-band antenna may be tuned to GPS (for position location information requests by portable computer 300 application software, a third multi-band antenna may be tuned to 2.4 GHz for Bluetooth short-range communication, and a fourth multi-band antenna may be tuned to 5-6 GHz for 802.11a WLAN operation. In a second example, the portable computer 300 may be configured to communicate using 802.11n and require the use of 2, 3 or 4 multi-band antennas simultaneously in the same operative frequency band and same RF channel. As is evident in the design of the multi-band antennas for this particular application, wireless communication device 312 within portable computer 300 may be reconfigured to tune individual multi-band antennas to serve a large number of communication modes and operative frequency bands as required.

Multi-band antenna 200b is a mirror image of multi-band antenna 200a. The mirrored multi-band antenna 200b is functionally identical to multi-band antenna 200a and may reduce the cable or electrical routing lengths between the multi-band antennas and the wireless communication device(s) embedded within the portable computer. Multi-band antennas 200a (two of each) and 200b (two of each) may be located along the top edge of the portable computer upper housing 302 and connected to ground plane 304 behind the portable computer 300 display. Alternately, the multi-band antennas 200a (two of each) and 200b (two of each) may be located on the sides of the portable computer upper housing 302 and connected to ground plane 304 behind the portable computer 300 display. Other multi-band antenna configurations are possible; i.e.; multi-band antennas may be split between the side and top edges of the portable upper housing 302, split between the portable upper housing 302 and the portable lower housing 308, or located only along the edges of the portable lower housing 308.

A wireless communication device 312 may be behind portable computer display on ground plane 304 (within upper housing 302, not shown) or may be placed on a portable computer motherboard (on motherboard 310) within main housing 308 (as shown). Typically in portable computers, the main housing 308 is connected to the upper housing 302 via a hinge or a swivel for tablet computers. In a typical portable computer 300, the wireless communication devices are located on motherboard 310 while the antennas are usually located within upper housing 302, and RF signals are routed through hinge/swivel 306 with RF cables. One of the benefits of the multi-band antennas 200a (two of each) and 200b (two of each) is that only four RF cables are needed regardless of the number of operative frequency bands per antenna as opposed to implementing separate antennas for individual operative frequency bands. Four RF multi-band antennas are sufficient for 802.11n (MIMO using all four multi-band antennas), as well as combinations of wide-area, local-area, and personal-area networking simultaneously. However, it's conceivable in the future that more than four multi-band antennas may be utilized for new applications of wireless communication devices.

FIG. 5 shows a diagram of a handheld wireless communication device 400 with two multi-band antennas. 200a and 200b in accordance with the exemplary embodiment as shown. Each multi-band antenna is tunable over a range of frequencies to cover potential communication modes and operative frequency bands.

Handheld wireless communication device 400 includes a housing 402 with a main circuit board (MCB 404). Multi-band antennas 200a and 200b connect to an upper edge of MCB 404 (RF signal path and ground plane connections). Multi-band antenna 200b is a mirror image of multi-band antenna 200a. Mirrored (in one dimension) multi-band antenna 200b is functionally identical to multi-band antenna 200a and the RF I/O ports are in close proximity on handheld wireless communication device main circuit board (MCB 404). Multi-band antennas 200a and 200b are typically located along the top edge of MCB 404 and connected to a ground plane within MCB 404. Alternately, multi-band antennas 200a and 200b may be located on one or both sides of MCB 404 and connected to a ground plane within MCB 404.

Alternative exemplary embodiments may include one multi-band antenna 200 or more multi-band antennas (not shown) depending on the number of simultaneous operative frequency bands within handheld wireless communication device 400. Multi-band antenna 200, 200a, 200b provide compact size and improved antenna efficiency over a broad range of operative frequency bands verses traditional antenna designs.

Wireless communication device 406 is embedded on MCB 404 within a main housing 402 as shown in FIG. 5. RF signals are routed to multi-band antennas 200a and 200b to/from wireless communication device 406 via metal traces printed on a layer of MCB 404 or alternatively routed with coaxial RF cables to minimize signal losses and noise coupling to RF signal paths.

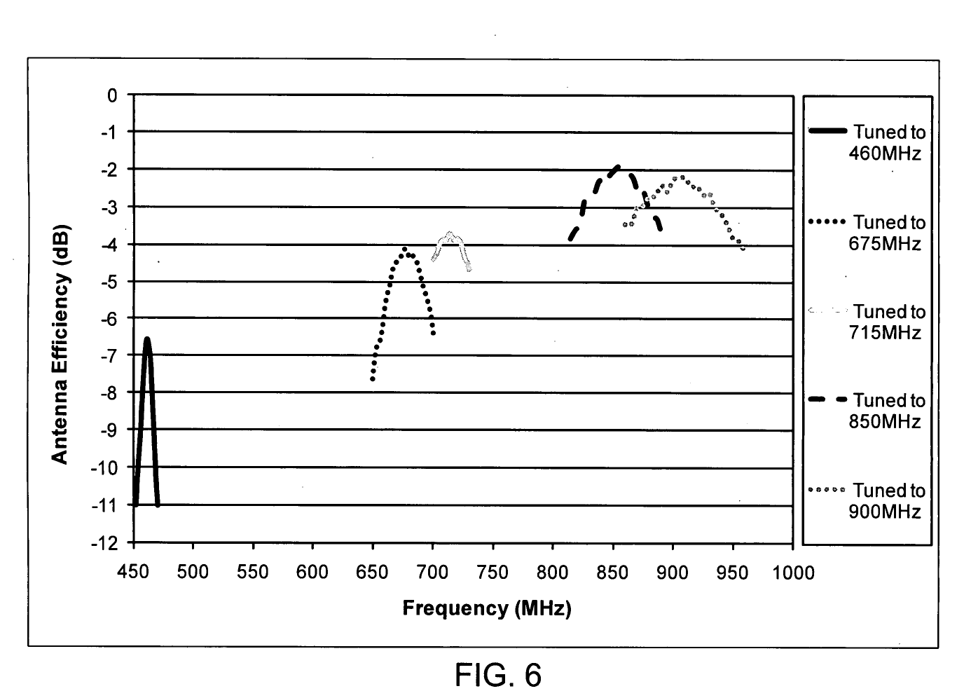

FIG. 6 shows a graph of the multi-band antenna efficiency (450 to 1000 MHz) for a portable computer configuration in accordance with the exemplary embodiment as shown previously in FIG. 3 and FIG. 4. As is evident in FIG. 6, the operative frequency bands are selectable between 460 MHz (CDMA450), 675 MHz (DVB-H), 715 MHz (US MediaFLO), 850 MHz (US Cellular), and 900 MHz (GSM-900). Therefore, multi-band antenna 200 can be configured by adjusting switch 128 position between five different antenna loading capacitors to shift the operative frequency band. More operative frequency bands can be chosen by either adding more ports (greater than five) to switch 128. Different operative frequency bands can be chosen by changing antenna loading capacitor values 132a-132e or changing the physical dimensions of modified monopole element 110a shown previously in FIG. 2.

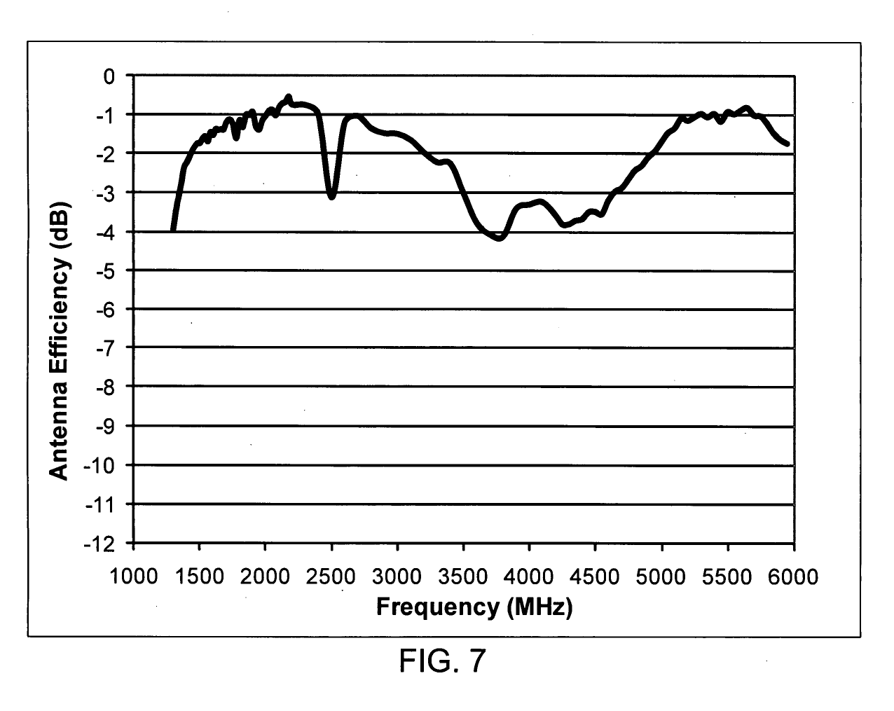

FIG. 7 shows a graph of the multi-band antenna efficiency (1000 to 6000 MHz) for a portable computer configuration in accordance with the exemplary embodiment as shown in FIG. 2, FIG. 3 and FIG. 4. As is evident in FIG. 7, the operative frequency bands are selectable between 1500 MHz (GPS), 1700 MHz (AWS), 1800 MHz (DCS, KPCS), 1900 MHz (US PCS), 2100 MHz (IMT), 2400 MHz and 4900-6000 MHz (802.11a/b/g/n). Therefore, multi-band antenna 200 can be configured by adjusting the switch 128 position between five different antenna loading capacitors to shift the operative frequency band. More operative frequency bands can be chosen by either adding more ports (greater than five) to switch 128 to cover the operative frequency bands shown previously in FIG. 6. Different operative bands can be chosen by changing antenna loading capacitor values 132a-132e or changing the physical dimensions of modified monopole element 110a of FIG. 2. In this instance, the number of operative frequency bands may not need to be equal to five, since the bandwidth of each operative frequency band is broader as the operative frequency is increased for a fixed folded monopole element 110a size.

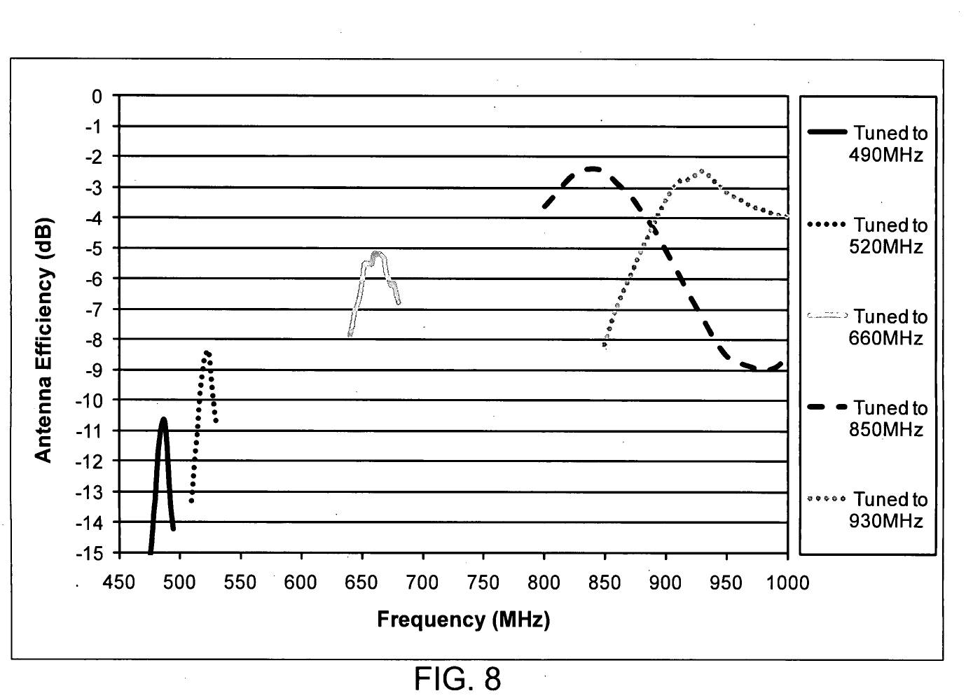

FIG. 8 shows a graph of the multi-band antenna efficiency (450 to 1000 MHz) for a handheld wireless communication device configuration in accordance with the exemplary embodiment as shown in FIG. 3 and FIG. 5. The multi-band antenna efficiency is very similar to FIG. 6 (for portable computer 300), however, the multi-band antenna efficiency is lower at 450 to 600 MHz since ground plane 404 physical dimensions are smaller than ground plane 304 physical dimensions within portable computer 300. The physical size of the ground plane for any antenna configuration is less important as the operative frequency is increased.

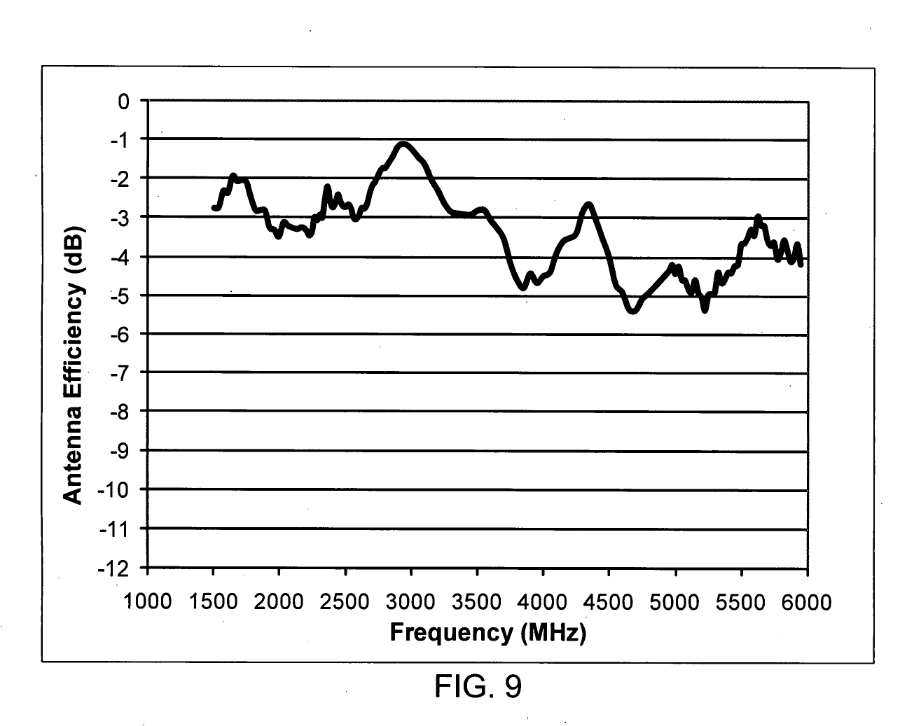

FIG. 9 shows a graph of the multi-band antenna efficiency (1000 to 6000 MHz) for a handheld wireless communication device configuration in accordance with the exemplary embodiment as shown in FIG. 3 and FIG. 5. The multi-band antenna efficiency is very similar to FIG. 6 since the ground planes are physically large for both the handheld wireless communication device 400 and for portable computer 300 above 1000 MHz operative frequency. It should be noted that the multi-band antenna 200 of FIG. 3 exhibits broad frequency coverage and excellent multi-band antenna efficiency regardless of the operative frequency bands chosen in this instance (450 MHz to 6000 MHz).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A multi-band antenna including a modified monopole element coupled to multiple antenna loading elements variably selectable to tune to one of a plurality of resonant frequencies.

2. The multi-band antenna of claim 1, wherein the modified monopole element has a geometry other than that of a traditional monopole element.

3. The multi-band antenna of claim 2, further comprising a switch array disposed between the modified monopole element and the multiple antenna loading elements) and configured to couple selected antenna loading elements) to the modified monopole element when tuning to a desired one of the plurality of resonant frequencies.

4. The multi-band antenna of claim 1, wherein the multi-band antenna is for use in a wireless communication device, the tuning to a plurality of resonant frequencies involves the wireless communication device selecting among the multiple antenna loading elements and tuning the multi-band antenna between operative frequency bands.

5. The multi-band antenna of claim 1, wherein the multi-band antenna includes matching elements.

6. The multi-band antenna of claim 2, wherein the multi-band antenna is printed on a flexible membrane.

7. The multi-band antenna of claim 2, wherein the multi-band antenna is formed as a stamped metal structure.

8. The multi-band antenna of claim 2, wherein the multi-band antenna is plated on a non-metal substrate.

9. The multi-band antenna of claim 2, wherein the multi-band antenna is etched on a non-metal substrate.

10. The multi-band antenna of claim 2, wherein the multi-band antenna is conductive ink deposited on a non-metal substrate.

11. The multi-band antenna of claim 2, wherein the multi-band antenna is part of a handheld wireless communication device.

12. The multi-band antenna of claim 2, wherein the multi-band antenna is part of a portable computer with an embedded wireless communication device.

13. The multi-band antenna of claim 3, wherein the switch array includes a single-pole n-throw (SPnT) switch.

14. The multi-band antenna of claim 13, wherein the single-pole n-throw (SPnT) switch is an integrated circuit.

15. The multi-band antenna of claim 6, wherein modified monopole element includes indents to enable changing of the physical dimensions of the multi-band antenna.

16. The multi-band antenna of claim 2, wherein the antenna loading elements comprise at least one of capacitors, voltage variable capacitors, inductors, LC circuits, and integrated LC circuits.

17. The multi-band antenna of claim 2, wherein the multi-band antenna is formed as a three dimensional metallized structure.

18. A multi-band antenna comprising:
a modified monopole element having a first radio frequency input, and a second radio frequency input for altering a resonant frequency;
a single-pole n-throw (SPnT) switch; and
an array of n antenna loading elements, one node of each antenna loading element connected to a corresponding one of n ports of the single-pole n-throw (SPnT) switch and the other node of each antenna loading element connected to a ground plane.

19. The multi-band antenna of claim 18, wherein the multi-band antenna is for use in a handheld wireless communication device and configured to operate in a plurality of resonant frequencies, the handheld wireless communication device selecting the position of the single-pole n-throw (SPnT) switch for tuning the multi-band antenna between operative frequency bands.

20. The multi-band antenna of claim 20, wherein the multi-band antenna is part of a handheld wireless communication device.

21. A multi-band antenna comprising:
a modified monopole element having a first radio frequency input, and m radio frequency inputs for altering a resonant frequency;
an array of m single-pole n-throw (SPnT) switches;
an array of m times n antenna loading elements, one node of each antenna loading element connected to one of the m times n ports of the array of m single-pole n-throw (SPnT) switches and the other node of each antenna loading element connected to a ground plane.

22. The multi-band antenna of claim 21, wherein the multi-band antenna is for use in a handheld wireless communication device and configured to operate in a plurality of resonant frequencies, the handheld wireless communication device selecting the position of the array of m single-pole n-throw (SPnT) switches for tuning the multi-band antenna between operative frequency bands.

23. The multi-band antenna of claim 21, wherein the multi-band antenna is printed on a flexible membrane.

24. The multi-band antenna of claim 21, wherein the modified monopole element is a folded modified monopole element including indents for changing the physical dimensions of the multi-band antenna.

25. A multi-band antenna, comprising:
a multi-band antenna with a modified monopole element;
multiple antenna loading elements coupled to the modified monopole element;
means for tuning to one of a plurality of resonant frequencies with the multiple antenna loading elements; and
means for controlling the multiple antenna loading elements between operative frequency bands.

26. A device including a multi-band antenna comprising:
a modified monopole element having a first radio frequency input, and m radio frequency inputs for altering a resonant frequency;
an array of m single-pole n-throw (SPnT) switches;
an array of m times n antenna loading elements, one node of each antenna loading element connected to one of the m times n ports of the array of m single-pole n-throw (SPnT) switches and the other node of each antenna loading element connected to a ground plane.

27. The device of claim 26, wherein the multi-band antenna includes an array of m DC blocking capacitors to block DC voltage between the common port of each single-pole n-throw (SPnT) switch and the m radio frequency inputs of the modified monopole element.

28. The device of claim 26, wherein the multi-band antenna is coupled to an external radio frequency port, and includes matching elements between the first radio frequency input and the external radio frequency port.

29. The device of claim 26, wherein a resonant frequency of the multi-band antenna is controlled by a wireless communication device selecting the position of each switch in the array of m single-pole single-pole n-throw (SPnT) switches for tuning the multi-band antenna between operative frequency bands.

30. The device of claim 26, wherein the device is at least one of a cellular phone and a portable computer comprising at least two multi-band antennas.
